(19) United States
(12) Patent Application Publication
(10) Pub. No.: US 2003/0229858 A1
(43) Pub. Date: Dec. 11, 2003

(54) Method and apparatus for providing source information from an object originating from a first document and inserted into a second document

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/165,083

(22) Filed: Jun. 6, 2002

(51) Int. Cl. G06F 17/00

(52) U.S. Cl. 715/526

(57) ABSTRACT

The present invention provides an improved method, apparatus, and computer instructions for providing source information from an object originating from a first document and inserted into a second document. The present invention automatically generates source information for an object that is cut or copied from a document and inserted into another document. The source information may be stored, hidden, or pasted into the second document, and also may automatically trigger the generation of a footnote for the second document. An application supplies the source information that the window manager extracts when an object is cut or copied from a document. The window manager requests the source information from the application displaying the first document. The application displaying the second document accepts the source information from the window manager when an object originating from the first document is inserted into the second document.

### BACKGROUND OF THE INVENTION

1. Technical Field

The present invention relates to an improved data processing system. In particular, the present invention relates to a method, apparatus, and computer instructions for providing source information from an object originating from a first document and inserted into a second document.

2. Description of Related Art

When writing research papers, source information has to be set up for objects, such as quotes, which have been cut or copied and pasted into a research paper or document. Source information is information used to identify the source of text or other objects, such as images or audio clips. This information includes, for example, copyright information, authorship information, and other information that may be used to create citations and footnotes to the source of the text or other objects. Often objects are cut or copied from one document and pasted into another document. Different objects, such as portions of text, images, or audio clips, from multiple documents may be pasted into a document. When the cut/copy and paste process is repeated many times, it may be difficult to remember from where the object was cut/copied so that source information can be gathered for the objects that have been pasted into a document. Additionally, it is time consuming and sometimes difficult to gather source information in order to create footnotes, copyright, and citation information for documents.

Therefore, it would be advantageous to have an improved method, apparatus, and computer instructions for providing source information from an object originating from a first document and inserted into a second document.

### SUMMARY OF THE INVENTION

The present invention provides an improved method, apparatus, and computer instructions for providing source information from an object originating from a first document and inserted into a second document. The present invention automatically generates source information for an object that is cut or copied from a document and inserted into another document. The source information may be stored, hidden, or pasted into the second document, and also may automatically trigger the generation of a footnote for the second document. An application supplies the source information that the window manager extracts when an object is cut or copied from a document. The window manager requests the source information from the application, such as for example, a word processor, browser, or editor, which displays the object originating from the first document. The application displaying the second document accepts the source information from the window manager when the object originating from a first document is inserted into the second document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram illustrating a data processing system in which the present invention may be implemented;

FIG. 3 is a block diagram illustrating a process to provide source information associated with an object cut or copied from one document and pasted into another document in accordance with a preferred embodiment of the present invention;

FIG. 4 is a block diagram of the process to generate authorship and copyright information associated with an object cut or copied from one document and pasted into another document in accordance with a preferred embodiment of the present invention;

FIG. 5 is a flowchart of the process for a window manager to extract authorship and copyright information for an object that is cut or copied from a document in accordance with a preferred embodiment of the present invention;

FIG. 6 is a flowchart of the process for maintaining authorship and copyright information for an object that is cut or copied from a document and pasted into another document in accordance with a preferred embodiment of the present invention; and

FIG. 7 is a flowchart of the process to generate source information for an object that is cut or copied from a document in accordance with a preferred embodiment of the present invention.

### DETAILED DESCRIPTION OF THE PREFERRED EMBODIMENT

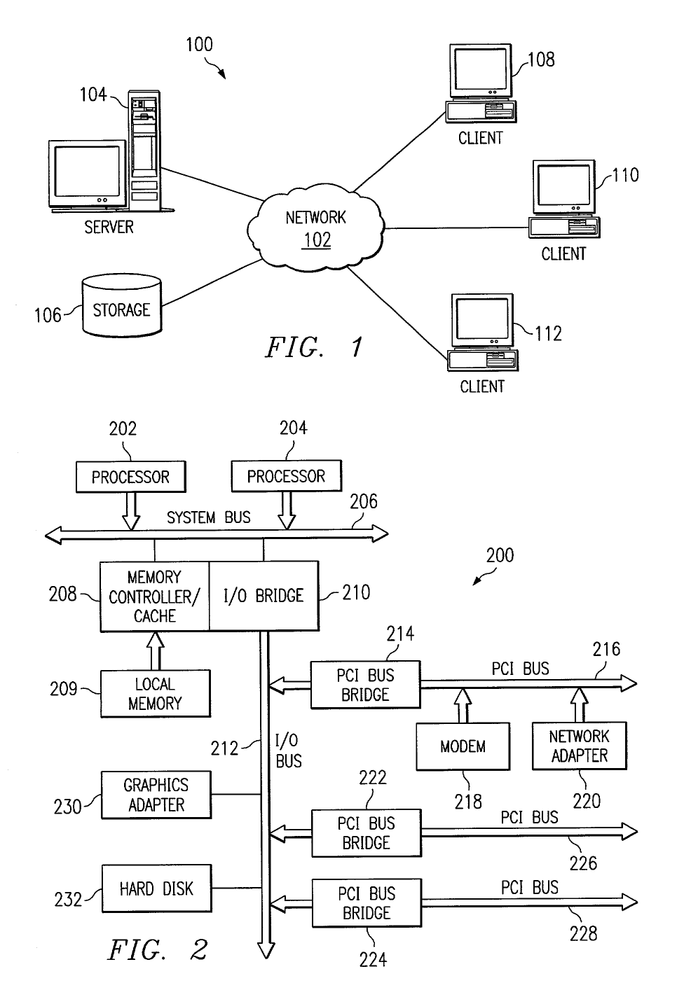

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

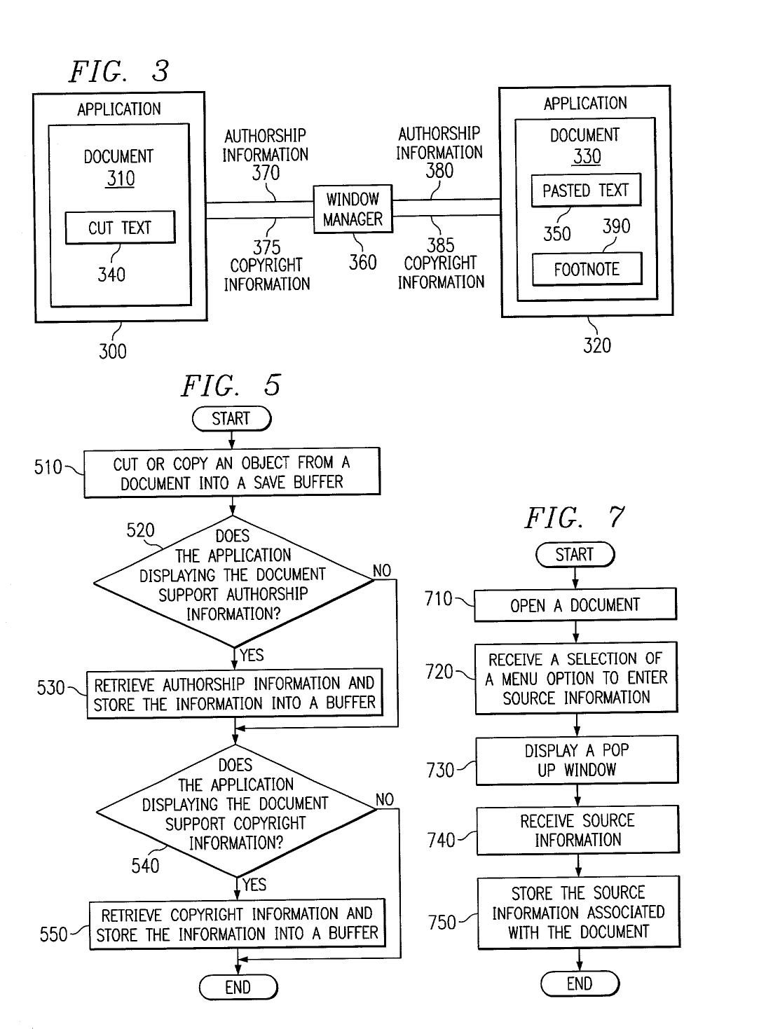

FIG. 3 is a block diagram illustrating a process to provide source information associated with an object cut or copied from one document and pasted into another document in accordance with a preferred embodiment of the present invention. Application 300 displays a document such as document 310. Application 320 displays another document such document 330. The user may select an object, such as a portion of text, to cut or copy from document 310, such as cut text 340. Cut text 340 is pasted into document 330 creating pasted text 350.

Window manager 360 extracts source information, such as authorship information 370 and copyright information 375 associated with cut text 340 from application 300 when an object, in this example cut text 340, is cut from document 310.

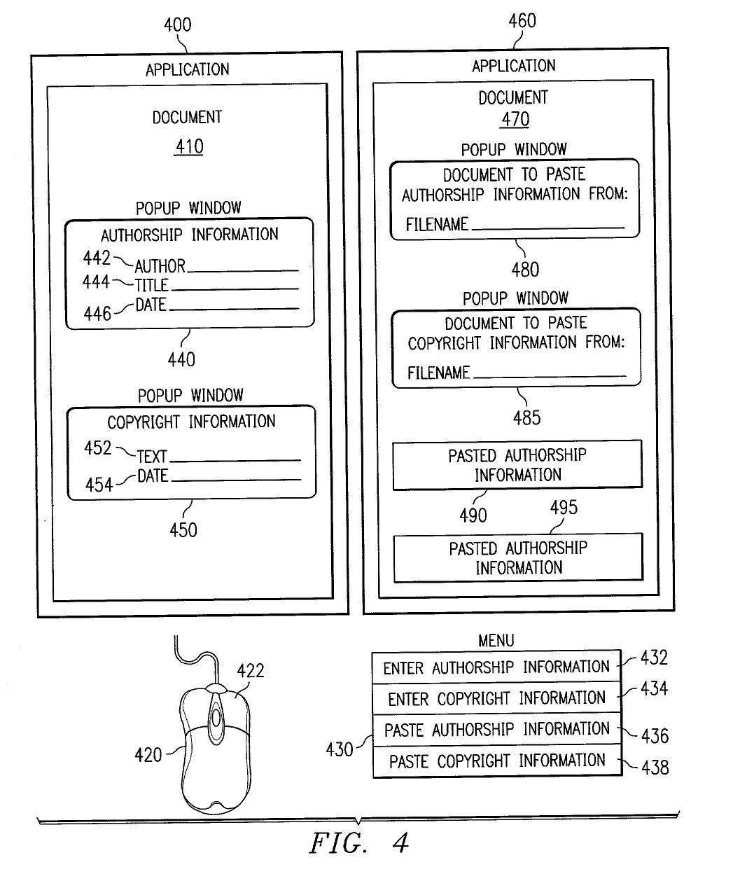

Window manager 360 retrieves authorship information 380 and copyright information 385 from application 320. If an application, such as application 320, does not maintain source information, the application is setup so that the user can enter the source information using a GUI interface discussed in more detail in FIG. 4.

Window manager 360 sends authorship information 380 and copyright information 385 to application 320 when cut text 340 is pasted into document 330. Application 320 may be an application such as, for example, Lotus Word Pro, Netscape Composer, Microsoft Word, the vi editor for UNIX, or other word processor, editor, or browser. If application 320, is an application such as Lotus Word Pro, application 320 would be setup to accept authorship information 380 and copyright information 385 so that footnote 390 is automatically generated when pasted text 350 is pasted into document 330.

An application such as the vi editor would not understand the source information; therefore, if application 320 is the vi editor, window manager 360 could paste the source information after pasted text 350 so that the user could use the information as needed. Additionally, if the document is a plain text file, the source information could be stored as an extended attribute. An extended attribute is user-defined information that is associated with the file. When the file is copied, the extended attribute is copied also. One common form of extended attribute is an ACL.

If application 320 is an application, such as Netscape Composer, application 320 could either setup footnotes, such as footnote 390, or hide source information in hidden fields inside of the HTML document. Each type of application may be setup to uniquely process the source information associated with the object cut or copied from a document and pasted into another document.

Objects may include items such as for example portions of text, images, or audio clips. The example illustrated in FIG. 3 uses text, but the present invention is not limited to text and may be applied to other objects such as images or audio clips.

FIG. 4 is a block diagram of the process to generate source information, such as for example, authorship and copyright information, associated with an object cut or copied from one document and pasted into another document in accordance with a preferred embodiment of the present invention.

Application 400 displays a document such as document 410. Mouse 420 may be, for example, an input device such as mouse 110 in FIG. 1. Mouse 420 is right clicked by depressing button 422 to generate menu 430, which contains menu options 432-438. Menu 430 contains menu option “Enter Authorship Information” 432. When menu option “Enter Authorship Information” 432 is selected, popup window 440 is displayed. Popup window 440 allows the user to enter authorship information, such as for example author 442, title 444, date 446, and time 448, for an object, which may be for example a portion of text. Menu 430 also contains menu option “Enter Copyright Information” 434. When menu option “Enter Copyright Information” 434 is selected, popup window 450 is displayed. Popup window 450 allows the user to enter copyright information, such as for example text 452 and date 454, for an object, which may be for example a portion of text.

The depicted examples are not meant to imply limitations, for example, the functionality of menu options 432 and 434 may be combined so that authorship and copyright information is entered in one popup window rather than two separate popup windows. Further, the popup windows may prompt for other or additional information to define the source information.

Application 460 displays a document such as document 470. Menu 430 contains menu option Paste Authorship Information 436. When menu option Paste Authorship Information 436 is selected, popup window 480 is displayed. Popup window 480 prompts for the information, such as the filename of the document to paste authorship information from, needed to retrieve the desired authorship information. Once the authorship information is retrieved, this information is pasted into document 470 as pasted authorship information 485. Similarly, menu 430 contains menu option “Paste Copyright Information” 438. When menu option “Paste Copyright Information” 438 is selected, popup window 490 is displayed. Popup window 490 prompts for the information, such as the filename of the document to paste copyright information from, needed to retrieve the desired copyright information. Once the copyright information is retrieved, it is pasted into document 470 as pasted copyright information 495. Again, the depicted examples are not meant to imply limitations, for example, the functionality of menu options 436 and 438 may be combined so that authorship and copyright information may be pasted in one step rather than two separate steps. Also, additional source information may be included in the menu options, such as, for example, citation information, an audio message from the author, author contact information, and ISBN number.

FIG. 5 is a flowchart of the process for a window manager to extract authorship and copyright information for an object that is cut or copied from a document in accordance with a preferred embodiment of the present invention.

An object is cut or copied from a document into a save buffer (step 510). A determination is made as to whether the application, displaying the document containing the cut or copied object, supports authorship information (step 520). If the application does not support authorship information, the process moves to step 540. If the application supports authorship information, the authorship information associated with the cut or copied object is retrieved and stored into a buffer (step 530). The process continues to the next step, in which a determination is made as to whether the application, displaying the document containing the cut or copied object, supports copyright information (step 540). If the application does not support copyright information, the process terminates. If the application supports copyright information, the copyright information associated with the cut or copied object is retrieved and stored into a buffer (step 550). The process terminates thereafter.

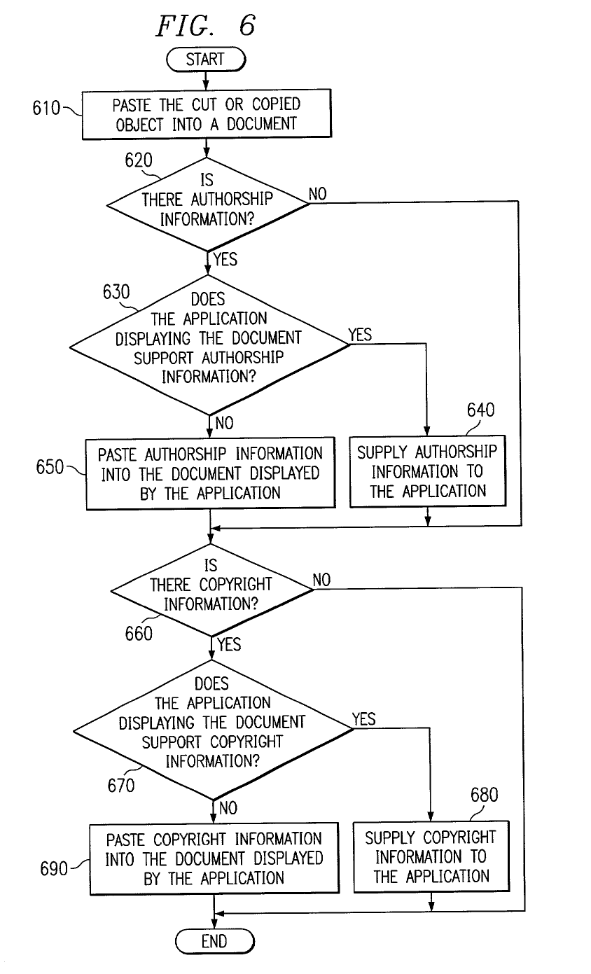

FIG. 6 is a flowchart of the process for maintaining authorship and copyright information for an object that is cut or copied from a document and pasted into another document in accordance with a preferred embodiment of the present invention.

An object, which has been cut or copied from a document, is pasted into another document (step 610). A determination is made as to whether authorship information is associated with the object (step 620). If authorship information is absent, the process continues to step 660. If authorship information is present, a determination is made as to whether the application displaying the pasted object supports authorship information (step 630).

If the application supports authorship information, the authorship information is supplied to the application for processing (step 640). The processing of the authorship information will vary depending on the setup of the application as discussed in FIG. 3. If the application does not support authorship information, the authorship information is pasted into the document after the pasted object, which is displayed by the application (step 650).

Next, a determination is made as to whether copyright information is associated with the object (step 660). If copyright information is absent, the process terminates thereafter. If copyright information is present, a determination is made as to whether the application displaying the pasted object supports copyright information (step 670). If the application supports copyright information, the copyright information is supplied to the application for processing (step 680). The processing of the copyright information will vary depending on the setup of the application as discussed in FIG. 3. If the application does not support copyright information, the copyright information is pasted into the document after the pasted object, which is displayed by the application (step 690). The process terminates thereafter.

FIG. 7 is a flowchart of the process to generate source information for an object that is cut or copied from a document in accordance with a preferred embodiment of the present invention.

The process begins with a document being opened (step 710). A selection of a menu option to enter source information is received (step 720). A popup window is displayed prompting for source information (step 730). Source information is received from input into the fields displayed by the popup window (step 740). The source information associated with a document or an object within a document is stored (step 750) with the process termination thereafter.

Thus, the present invention provides an improved method, apparatus, and computer instructions for maintaining buffer history from portions of text cut from a first document and pasted into a second document. The present invention saves time and confusion in the creation of authorship and copyright information for portions of text cut from one document and pasted into another since the information is automatically supplied to the application containing the document with the pasted text.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for automatically providing source information associated with an object, the method comprising:
requesting the source information from a first application displaying a first document containing the object, wherein the object originates from the first document;
retrieving the source information from the first application displaying the object; and
sending the source information to a second application displaying a second document in which the object has been inserted into the second document, wherein the second application associates the source information with the object.

2. The method of claim 1, wherein the source information includes at least one of a footnote, authorship information, copyright information, and citation information.

3. The method of claim 1, wherein a window manger performs the requesting step.

4. The method of claim 1 further comprising:
receiving the source information associated with the object by the second application.

5. The method of claim 1, wherein the retrieving step includes:
using a window manager to extract the source information when the object is cut or copied from the first document.

6. The method of claim 1 further comprising:
accepting the source information in the second application when the object is inserted into the second document.

7. The method of claim 1, wherein the second application is setup to accept source information.

8. The method of claim 7, further comprising:
processing the source information.

9. The method of claim 8, wherein the processing step includes automatically setting up footnotes.

10. The method of claim 7, wherein the processing step includes at least one of storing, hiding, and pasting the source information.

11. A method in a data processing system for generating source information associated with an object, the method comprising:
entering the source information for the object, wherein the object originates from a document; and
storing the source information associated with the object.

12. The method of claim 11, further comprising:
modifying an application to support the source information.

13. The method of claim 11, wherein the entering step includes activating a popup window to prompt for source information.

14. The method of claim 13, wherein the popup window queries the source information.

15. The method of claim 11, wherein the storing step includes storing the source information in at least one of a buffer, a hidden field, a register, a database, an extended attribute, a document, and a file.

16. The method of claim 11, further comprising:
selecting a menu option to enter the source information.

17. A method in a data processing system for managing source information, the method comprising:
responsive to detecting an insertion of an object into a document in a target application, obtaining source information for the object from a source application from which the object was obtained; and
sending the source information to the target application.

18. The method of claim 17, wherein the source information for the object is obtained by the source application through a user input entering the source information.

19. The method of claim 17, wherein the target application creates a footnote associated with the object within the document using the source information.

20. The method of claim 17 further comprising:
responsive to a selected user input, prompting the user to enter source information to form entered source information; and
storing the entered source information in association with the object.

21. The method of claim 17, wherein the object is text.

22. The method of claim 17, wherein the object is at least one of text, an image, an audio file, or a spreadsheet.

23. A data processing system comprising:
a bus system;
a communications unit connected to the bus system;
a memory connected to the bus system, wherein the memory includes as set of instructions; and
a processing unit connected to the bus system, wherein the processing unit executes the set of instructions to request the source information from a first application displaying a first document containing the object, wherein the object originates from the first document; retrieve the source information from the first application displaying the object; and send the source information to a second application displaying a second document in which the object has been inserted into the second document, wherein the second application associates the source information with the object.

24. A data processing system for automatically providing source information associated with an object, the data processing system comprising:
requesting means for requesting the source information from a first application displaying a first document containing the object, wherein the object originates from the first document;
retrieving means for retrieving the source information from the first application displaying the object; and
sending means for sending the source information to a second application displaying a second document in which the object has been inserted into the second document, wherein the second application associates the source information with the object.

25. A computer program product in a computer readable medium for automatically providing source information associated with an object, the computer program product comprising:
first instructions for requesting the source information from a first application displaying a first document containing the object, wherein the object originates from the first document;
second instructions for retrieving the source information from the first application displaying the object; and
third instructions for sending the source information to a second application displaying a second document in which the object has been inserted into the second document, wherein the second application associates the source information with the object.

26. A data processing system comprising:
a bus system;
a communications unit connected to the bus system;
a memory connected to the bus system, wherein the memory includes as set of instructions; and
a processing unit connected to the bus system, wherein the processing unit executes the set of instructions to enter the source information for the object, wherein the object originates from a document; and store the source information associated with the object.

27. A data processing system for generating source information associated with an object, the data processing system comprising:
entering means for entering the source information for the object, wherein the object originates from a document; and
storing means for storing the source information associated with the object.

28. A computer program product in a computer readable medium for generating source information associated with an object, the computer program product comprising:
first instructions for entering the source information for the object, wherein the object originates from a document; and
second instructions for storing the source information associated with the object.

29. A data processing system comprising:
a bus system;
a communications unit connected to the bus system;
a memory connected to the bus system, wherein the memory includes as set of instructions; and
a processing unit connected to the bus system, wherein the processing unit executes the set of instructions, responsive to detecting an insertion of an object into a document in a target application, to obtain source information for the object from a source application from which the object was obtained; and send the source information to the target application.

30. A data processing system for managing source information, the data processing system comprising:
responsive to detecting an insertion of an object into a document in a target application, obtaining means for obtaining source information for the object from a source application from which the object was obtained; and
sending means for sending the source information to the target application.

31. A computer program product in a computer readable medium for managing source information, the computer program product comprising:
responsive to detecting an insertion of an object into a document in a target application, first instructions for obtaining source information for the object from a source application from which the object was obtained; and
second instructions for sending the source information to the target application.
